(19) United States
(12) Patent Application Publication
(10) Pub. No.: US 2015/0163260 A1
(43) Pub. Date: Jun. 11, 2015

(54) Systems and Methods for Messaging Multiple Devices

(71) Applicant: Google Inc., Mountain View, CA (US)

(72) Inventors: Tal Dayan, Los Gatos, CA (US); Subir Jhanb, Sunnyvale, CA (US)

(73) Assignee: Google Inc., Mountain View, CA (US)

(21) Appl. No.: 14/102,277

(22) Filed: Dec. 10, 2013

(51) Int. Cl. H04L 29/06

(52) U.S. Cl. CPC H04L 65/403

(57) ABSTRACT

Certain implementations of the disclosed technology may include systems, methods, and computer-readable media for disseminating messages to multiple devices. According to an example implementation, a method is provided that includes receiving, at one or more computing systems, a rule comprising a message and routing instructions for dissemination of the message to at least two of a plurality of computing devices in communication with the one or more computing systems. The method includes extracting from the rule, by at least one of the one or more computing systems, the message and routing instructions; determining, from the routing instructions and from device information, the at least two of the plurality of computing devices for dissemination of the message; and sending, based on the routing instructions, the extracted message to the at least two of the plurality of computing devices.

### BACKGROUND

Current cloud messaging services are typically designed for sending messages to one device at a time. Sending a message to a particular device or to a group of devices can require overhead for each message. For example, sending the same message to several targeted device may require overhead to look-up and/or determine which device is connected to which server. Time-sensitive, mass-messaging notifications, such as network outage alerts, emergency alerts, etc., that require dissemination to a large number devices in a short time period may not be practical with the current cloud messaging infrastructure. A need exists for efficiently sending messages to a large number of mobile devices.

### SUMMARY

Some or all of the above needs may be addressed by certain implementations of the disclosed technology. Certain implementations may include systems and methods for disseminating messages to many devices.

According to an example implementation, a method is provided that includes receiving, at one or more computing systems, a rule comprising a message and routing instructions for dissemination of the message to at least two of a plurality of computing devices that are configured to communicate with the one or more computing systems. The method includes extracting from the rule, by at least one of the one or more computing systems, the message and routing instructions; determining, from the routing instructions and from device information, the at least two of the plurality of computing devices for dissemination of the message; and sending, based on the routing instructions, the extracted message to the at least two of the plurality of computing devices.

According to another example implementation, a system is provided that includes one or more processors; and memory storing instructions that when executed by the one or more processors cause the computing system to perform operations including: receiving a rule that includes a message and routing instructions for dissemination of the message to at least two of a plurality of computing devices that are configured to communicate with the computing system; extracting from the rule, the message and routing instructions; determining, from the routing instructions and from device information, the at least two of the plurality of computing devices for dissemination of the message; and sending, based on the routing instructions, the extracted message to the at least two of the plurality of computing devices.

According to another example implementation, a computer-readable media is provided that stores instructions, that when executed by a computer device having one or more processors, cause the computer device to perform a method. The method includes receiving, at one or more computing systems, a rule comprising a message and routing instructions for dissemination of the message to at least two of a plurality of computing devices configured to communicate with the one or more computing systems. The method includes extracting from the rule, by at least one of the one or more computing systems, the message and routing instructions; determining, from the routing instructions and from device information, the at least two of the plurality of computing devices for dissemination of the message; and sending, based on the routing instructions, the extracted message to the at least two of the plurality of computing devices.

Other implementations, features, and aspects of the disclosed technology are described in detail herein and are considered a part of the claimed disclosed technology. Other implementations, features, and aspects can be understood with reference to the following detailed description, accompanying drawings, and claims.

### BRIEF DESCRIPTION OF THE FIGURES

Reference will now be made to the accompanying figures and flow diagrams, which are not necessarily drawn to scale, and wherein:

FIG. 1 is an illustrative communication system 100, according to an example implementation of the disclosed technology.

FIG. 2 is an illustrative block diagram 200 of the communication system 100, according to an example implementation of the disclosed technology.

FIG. 3 is a block diagram of an illustrative computing system 300 according to an example implementation of the disclosed technology.

FIG. 4 is a flow diagram of a method 400 according to an example implementation of the disclosed technology.

### DETAILED DESCRIPTION

Some implementations of the disclosed technology will be described more fully hereinafter with reference to the accompanying drawings. This disclosed technology may, however, be embodied in many different forms and should not be construed as limited to the implementations set forth herein.

Example embodiments of the disclosed technology can enable sending a message to a very large number of devices in a relatively short time. Certain embodiments may utilize a rule that may be processed at a computing system, such as a connection or messaging server, and may include the message and routing instructions for dissemination to certain devices in communication with the computing system. For example, the rule may tell the server how to distribute the message to the mobile devices that are configured to communicate with the server.

In one example implementation, the rule may include instructions to “send this message to all connected devices.” In other example implementations, mass messages may be filtered or customized at the server based on the rule; for example: “only send this message to devices associated with cellular carrier XYZ.” In other example implementations, messages may be customized at the server based on destination information included in the rule routing instructions. For example, messages destined for certain regions or countries may be translated at the server into the destination language prior to being delivered. In another example implementation, the rule may include pre-translated messages for appropriate selection and dissemination to the various destinations.

Example implementations of the disclosed technology may provide enhanced efficiency with reduced overhead for mass messaging. An illustration of how the disclosed technology can provide scaling efficiency can be understood by considering a comparison with current messaging methods. For example, sending messages to one billion devices using conventional technology may require preparing and sending one billion messages, with all of the associated overhead lookup, routing information, etc., for each message. However, according to an illustrative example of the disclosed technology, if the one billion devices were connected to 10 thousand message servers, then only 10 thousand rules (including messages and routing instructions) need to be sent—one rule to each server. This illustrative example represents an approximate 100,000-fold reduction in the number of generated messages and associated overhead. A significant decrease in the overall time required to send messages to many devices may be realized using embodiments of the disclosed technology.

In accordance with an example implementation of the disclosed technology, the computing system may communicate via persistent, asynchronous, and/or bidirectional connections with the various computing devices that are configured for communication with the computing system. In the various example embodiments disclosed herein, the computing system may be embodied as a server, such as a connection server, and may be configured to communicate with a plurality of mobile computing device. In an example implementation, device information, such as connection credentials may be utilized by the connection server or by a registration server to authenticate communications with the target devices and to ensure that messages are correctly routed to/from the connection server. In certain example implementations, the connection server may maintain (or may be in communication with) a database of device information such as attached and registered devices. For example, the connection server may include a dynamic lookup table that includes device information for identifying device IDs, tokens, credentials, connection information, etc. In certain example implementations, the device information database may be utilized in conjunction with the rule to disseminate extracted messages to the end devices based on extracted routing instructions.

In an example implementation, a registration ID may be issued by the connection servers to the target device, allowing the device to receive messages. In an example implementation, the registration ID may be utilized it identify that the device has registered to receive messages. For example, a registration ID may be tied to a particular device, and a particular connection server may maintain the list (i.e., device information) of the devices that are authorized for receiving messages from that particular connection server. In certain example implementations, the device information, registration ID, and/or token may further provide capability, connection status, network details, regional information, language information, etc., about the target device, and such information may be utilized in the extraction, translation and/or sending of the messages to particular devices.

Various systems and methods may be utilized for sending messages to many devices, according to example implementations of the disclosed technology, and will now be described with reference to the accompanying figures.

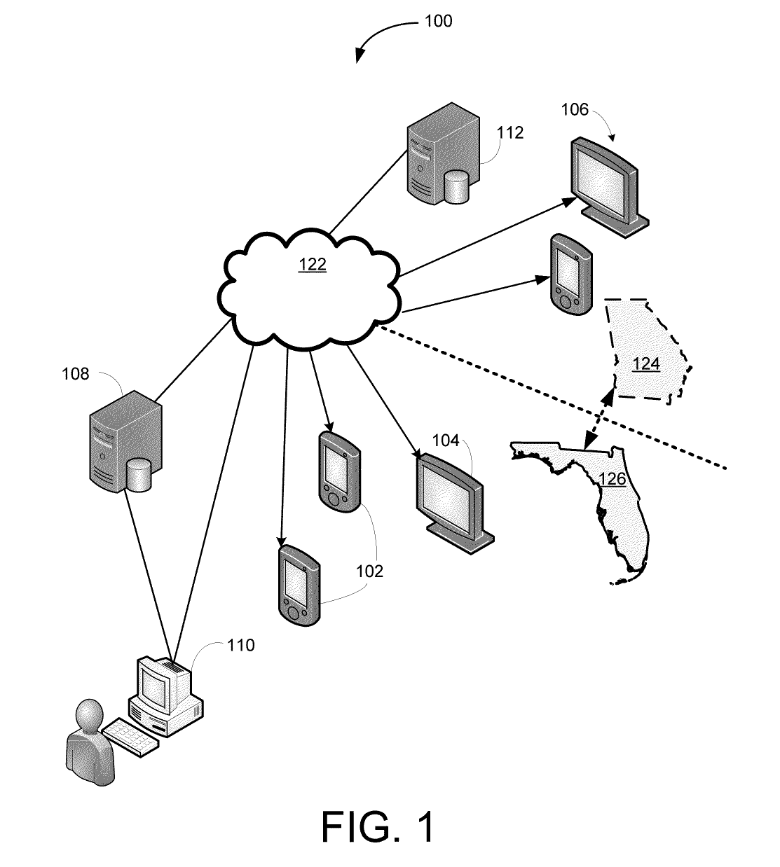

FIG. 1 depicts an illustrative communication system 100 for disseminating messages to many computing devices. In accordance with an example implementation of the disclosed technology, a rule distribution server 110 may be in communication with one or more connection servers 108 112, either directly, or via a cloud network or internet connection 122. In one example implementation, the connection servers 108 112 may be in communication with the various destination computing devices 102 104 106. In certain example implementations, the connection servers 108 112 may connect with the various destination computing devices 102 104 106 according to geographical locations 124 126. For example, in one example embodiment, certain computing devices 102 104 may be associated with a first region 126 and may be serviced primarily via a first connection server 108, while other computing devices 106 in a second geographical region 124 may be serviced by a second connection server 112.

According to an example implementation of the disclosed technology, a rule may be sent to the connection servers 108 112 and may include a message and routing instructions. In one example implementation, the routing instructions may provide instructions for the first connection server 108 to send the message only to certain devices 102 that are associated with a certain carrier. In another example implementation, the rule may include routing instructions to instruct the second connection server 112 to translate the message for the destined region 124, and to send the translated message to each of the computing devices 106 in the associated second region 124. In yet another example implementation, the rule may include routing instructions to send an appropriately translated message to all devices having certain criteria, for example, only to devices that are smart phones. Many other rule-based message distribution scenarios may be achieved according to example embodiments of the technology, and are not limited to those discussed herein.

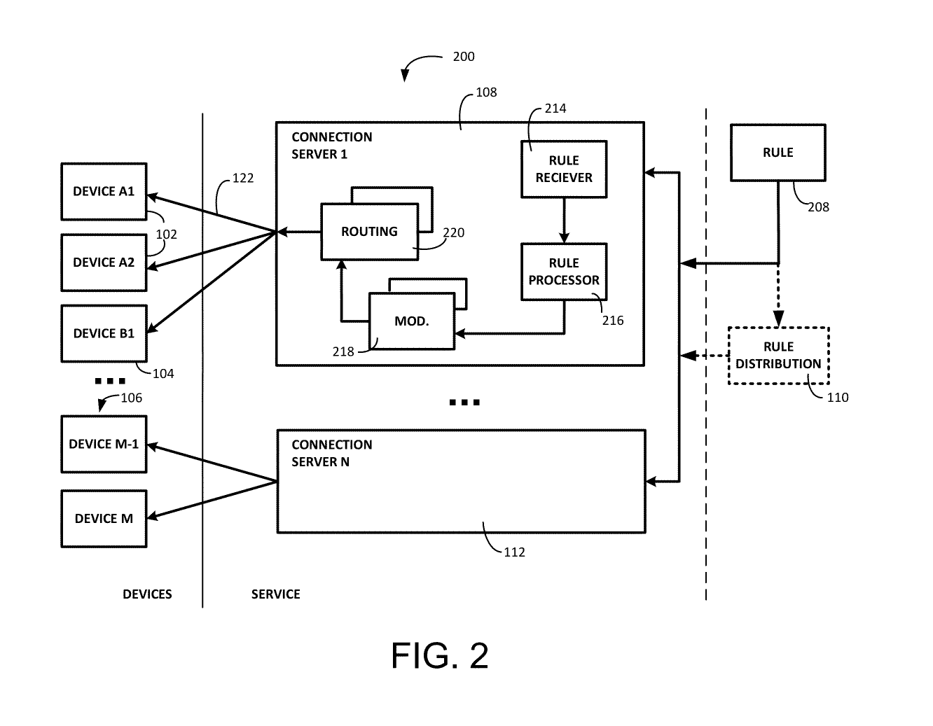

FIG. 2 is an illustrative block diagram 200 of the communication system 100 as shown in FIG. 1. In accordance with an example embodiment, messages may be delivered 122 in an efficient manner to a large number of computing devices 102 104 106 by connection servers 108 112 in communication with the plurality of computing devices. According to an example embodiment, a rule 208 may be generated and distributed to a rule distribution node 110. The rule 208 for example, can include data comprising one or more messages and routing instructions. Such information may be utilized by the rule distribution node 110 and the connection servers 108 112 to properly route and/or to modify a message, for example, as needed based on the destination of the message.

In an example implementation, the rule distribution node 110 can examine the contents of the rule 208 and appropriately distribute the rule 208 to the appropriate connection server(s) 108 112. For example, the routing instructions associated with the rule 208 may specify that the message should be distributed only to those devices in certain regions of the world. Thus, according to one example implementation, the rule distribution node 110 may send the rule 208 (and the associated message) to only those connection servers that are associated with devices in the target regions. In this example embodiment, the rule 208 may be distributed to appropriate connection servers. However, in another example implementation, the rule 208 may be sent to all connection servers and the distribution of the rule 208 may be done by the connection servers 108 112. For example, in certain example embodiments, the function(s) associated with the rule distribution node 110 may be handled by the connection servers 108 112 and the external rule distribution node 110 may not be required.

FIG. 2 depicts a first connection server 108 with block diagrams to perform the various functions associated with the dissemination of the message(s). For example, embodiments may including a rule receiver 214 to receive the rule, a rule processor 216 to extract the message, a modification block 218 to modify the message (if instructed to do so by the rule), and a routing block 220 for sending the message(s) to the appropriate devices 102 104 via the appropriate connections 122. Thus, it should be readily apparent to one skilled in the art that numerous variations of routing and modification of a mass distribution of messages may be enabled herein. For example, certain devices A1 A2 102, B1 104 may be associated with a particular service, but devices A1 A2 102 could be smartphones while device B1 104 could be some other device, such as an entertainment appliance, or other web-enabled device. If a message needs to reach only smartphones associated with a particular service provider (but not to any other devices) then the rule 208 may include such specific routing information and the connection server 108 may appropriately filter/route/modify the message based on the routing information and only send the message to smartphone devices A1 A2 102.

In another example implementation, and as may be explained again with reference to FIG. 2, the rule 208 may include instructions to send a message to all devices 102 104 106 but to translate the language of the message to the language appropriate to the region of the target devices. In one example implementation, the message translation may be processed at the connection servers (for example, in the message modification 218 block). In another example implementation, the language of the message may be translated at the rule distribution node 110.

According to other example implementations of the disclosed technology, message dissemination to devices may be based on various phenomena, including, but not limited to timing, acknowledgements, capabilities of the device, connection status of the device, etc. For example, a time-sensitive message may be destined for a particular device that is currently offline. In an example implementation, the rule 208 may instruct the server to continue attempting to send the message periodically until a timeout value is reached. For example, the rule may specify that the message is valid for less than 24 hours.

In one example implementation, message dissemination to a device may be based on an acknowledgement that a device is actually connected to the connection server 108 112. For example, the rule 208 could specify that the message should be sent to a device only if it is known or verified that the device is connected. According to an example implementation, messages may be disseminated and/or otherwise controlled based on network status, traffic, speed issues, available bandwidth, etc.

In accordance with an example implementation of the disclosed technology, the message may include texts, photos, graphics, videos, etc. In one example implementation, a universal resource locater (URL) targeting content may be sent in the message (rather than sending the actual content) with instructions for the end device to fetch the content referenced by the URL.

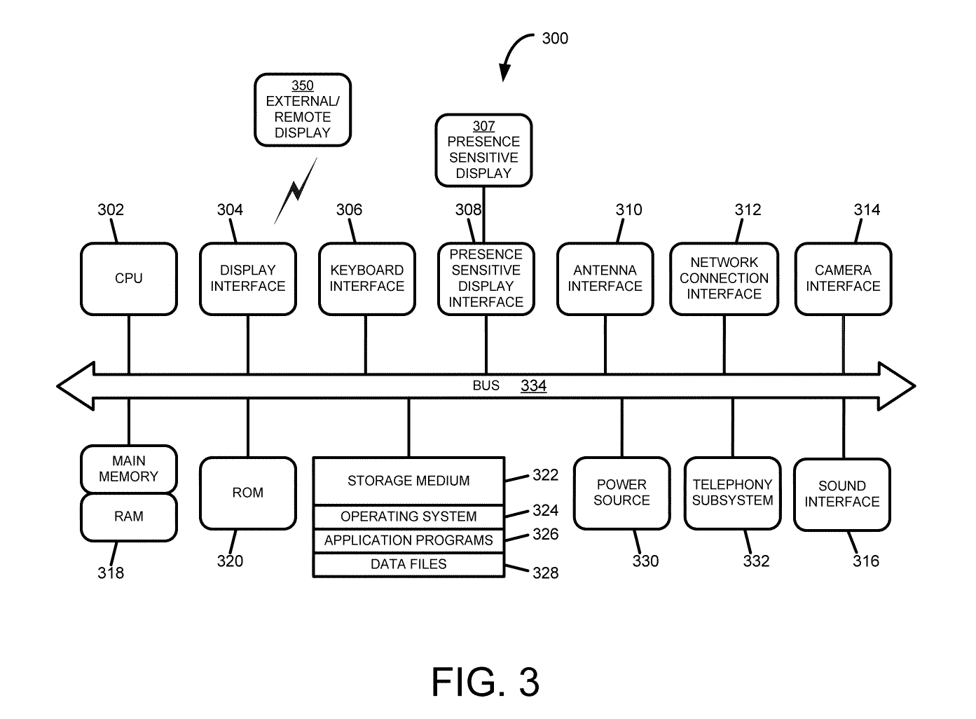

FIG. 3 is a block diagram of an illustrative computing system 300 according to an example implementation of the disclosed technology. Certain aspects of FIG. 3 may be embodied in a mobile computing device (for example, the mobile computing devices 102 as shown in FIGS. 1 and 2). Certain aspects of FIG. 3 may be embodied in a server (for example, the connection server 108 112 as shown in FIGS. 1 and 2). Various implementations and methods herein may be embodied in non-transitory computer readable media for execution by a processor. It will be understood that the computing device 300 is provided for example purposes only and does not limit the scope of the various implementations of the communication systems and methods.

The computing device 300 of FIG. 3 includes a central processing unit (CPU) 302, where computer instructions are processed; a display interface 304 that acts as a communication interface and provides functions for rendering video, graphics, images, and texts on the display. In certain example implementations of the disclosed technology, the display interface 304 may be directly connected to a local display, such as a touch-screen display associated with a mobile computing device. In another example implementation, the display interface 304 may be configured for providing data, images, and other information for an external/remote display 350 that is not necessarily physically connected to the mobile computing device. For example, a desktop monitor may be utilized for mirroring graphics and other information that is presented on a mobile computing device. In certain example implementations, the display interface 304 may wirelessly communicate, for example, via a Wi-Fi channel or other available network connection interface 312 to the external/remote display 350.

In an example implementation, the network connection interface 312 may be configured as a communication interface and may provide functions for rendering video, graphics, images, text, other information, or any combination thereof on the display. In one example, a communication interface may include a serial port, a parallel port, a general purpose input and output (GPIO) port, a game port, a universal serial bus (USB), a micro-USB port, a high definition multimedia (HDMI) port, a video port, an audio port, a Bluetooth port, a near-field communication (NFC) port, another like communication interface, or any combination thereof. In one example, the display interface 304 may be operatively coupled to a local display, such as a touch-screen display associated with a mobile device. In another example, the display interface 304 may be configured to provide video, graphics, images, text, other information, or any combination thereof for an external/remote display 350 that is not necessarily connected to the mobile computing device. In one example, a desktop monitor may be utilized for mirroring or extending graphical information that may be presented on a mobile device. In another example, the display interface 304 may wirelessly communicate, for example, via the network connection interface 312 such as a Wi-Fi transceiver to the external/remote display 350.

The computing device 300 may include a keyboard interface 306 that provides a communication interface to a keyboard. In one example implementation, the computing device 300 may include a presence sensitive display interface 308 for connecting to a presence-sensitive display 307. According to certain example implementations of the disclosed technology, the presence sensitive display interface 308 may provide a communication interface to various devices such as a pointing device, a touch screen, a depth camera, etc. which may or may not be associated with a display.

The computing device 300 may be configured to use an input device via one or more of input/output interfaces (for example, the keyboard interface 306, the display interface 304, the presence sensitive display interface 308, network connection interface 312, camera interface 314, sound interface 316, etc.,) to allow a user to capture information into the computing device 300. The input device may include a mouse, a trackball, a directional pad, a track pad, a touch-verified track pad, a presence-sensitive track pad, a presence-sensitive display, a scroll wheel, a digital camera, a digital video camera, a web camera, a microphone, a sensor, a smartcard, and the like. Additionally, the input device may be integrated with the computing device 300 or may be a separate device. For example, the input device may be an accelerometer, a magnetometer, a digital camera, a microphone, and an optical sensor.

Example implementations of the computing device 300 may include an antenna interface 310 that provides a communication interface to an antenna; a network connection interface 312 that provides a communication interface to a network. As mentioned above, the display interface 304 may be in communication with the network connection interface 312, for example, to provide information for display on a remote display that is not directly connected or attached to the system. In certain implementations, a camera interface 314 is provided that acts as a communication interface and provides functions for capturing digital images from a camera. In certain implementations, a sound interface 316 is provided as a communication interface for converting sound into electrical signals using a microphone and for converting electrical signals into sound using a speaker. According to example implementations, a random access memory (RAM) 318 is provided, where computer instructions and data may be stored in a volatile memory device for processing by the CPU 302.

According to an example implementation, the computing device 300 includes a read-only memory (ROM) 320 where invariant low-level system code or data for basic system functions such as basic input and output (I/O), startup, or reception of keystrokes from a keyboard are stored in a non-volatile memory device. According to an example implementation, the computing device 300 includes a storage medium 322 or other suitable type of memory (e.g. such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, flash drives), where the files include an operating system 324, application programs 326 (including, for example, a web browser application, a widget or gadget engine, and or other applications, as necessary) and data files 328 are stored. According to an example implementation, the computing device 300 includes a power source 330 that provides an appropriate alternating current (AC) or direct current (DC) to power components. According to an example implementation, the computing device 300 includes and a telephony subsystem 332 that allows the device 300 to transmit and receive sound over a telephone network. The constituent devices and the CPU 302 communicate with each other over a bus 334.

In accordance with an example implementation, the CPU 302 has appropriate structure to be a computer processor. In one arrangement, the computer CPU 302 may include more than one processing unit. The RAM 318 interfaces with the computer bus 334 to provide quick RAM storage to the CPU 302 during the execution of software programs such as the operating system application programs, and device drivers. More specifically, the CPU 302 loads computer-executable process steps from the storage medium 322 or other media into a field of the RAM 318 in order to execute software programs. Data may be stored in the RAM 318, where the data may be accessed by the computer CPU 302 during execution. In one example configuration, the device 300 includes at least 128 MB of RAM, and 256 MB of flash memory.

The storage medium 322 itself may include a number of physical drive units, such as a redundant array of independent disks (RAID), a floppy disk drive, a flash memory, a USB flash drive, an external hard disk drive, thumb drive, pen drive, key drive, a High-Density Digital Versatile Disc (HD-DVD) optical disc drive, an internal hard disk drive, a Blu-Ray optical disc drive, or a Holographic Digital Data Storage (HDDS) optical disc drive, an external mini-dual in-line memory module (DIMM) synchronous dynamic random access memory (SDRAM), or an external micro-DIMM SDRAM. Such computer readable storage media allow the device 300 to access computer-executable process steps, application programs and the like, stored on removable and non-removable memory media, to off-load data from the device 300 or to upload data onto the device 300. A computer program product, such as one utilizing a communication system may be tangibly embodied in storage medium 322, which may comprise a machine-readable storage medium.

According to one example implementation, the term computing device, as used herein, may be a CPU, or conceptualized as a CPU (for example, the CPU 302 of FIG. 3). In this example implementation, the computing device (CPU) may be coupled, connected, and/or in communication with one or more peripheral devices, such as display. In another example implementation, the term computing device, as used herein, may refer to a mobile computing device, such as a smartphone or tablet computer. In this example embodiment, the computing device may output content to its local display and/or speaker(s). In another example implementation, the computing device may output content to an external display device (e.g., over Wi-Fi) such as a TV or an external computing system.

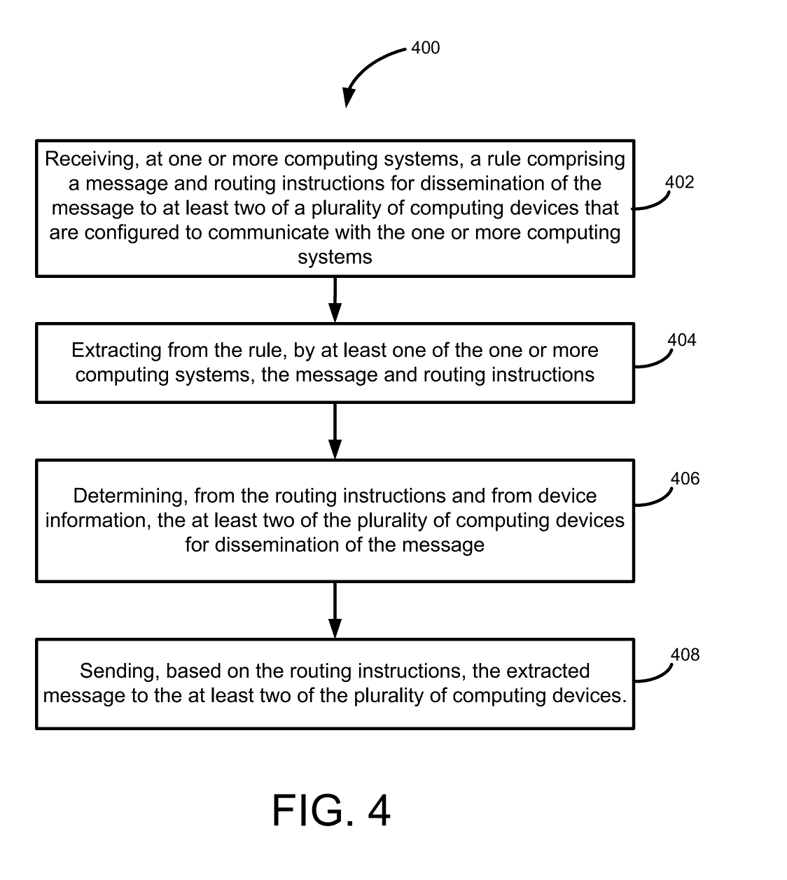

An example method 400 for disseminating messages to multiple devices will now be described with reference to the flowchart of FIG. 4. The method 400 starts in block 402, and according to an example implementation includes receiving, at one or more computing systems, a rule comprising a message and routing instructions for dissemination of the rule to at least two of a plurality of computing devices configured for communication with the one or more computing systems. In block 404, the method 400 includes extracting from the rule, by at least one of the one or more computing systems, the message and routing instructions. In block 406, the method 400 includes determining, from the routing instructions and from device information, the at least two of the plurality of computing devices for dissemination of the message. In block 408, the method 400 includes sending, based on the routing instructions, the extracted message to the at least two of the plurality of computing devices.

In certain example implementations, the device information may include connectivity and/or registration information that may include current information about the computing device, including but not limited to one or more of device type, model number, brand, serial number, account credentials, battery charge, whether the device is plugged-in, network status, device capabilities, geographical region, etc. Such information may be utilized, in an example embodiment, in the messaging of the device.

According to an example implementation of the disclosed technology, the version of the extracted message can include a modified extracted message that is based, at least in part, on the routing instructions. In an example implementation, the rule further can further include a time criteria, the may include one or more of a start time or a stop time, and wherein sending the version of the extracted message to at least a portion of the plurality of computing devices is controlled by the time criteria. In certain example implementations, the rule further includes destination criteria, and wherein sending the version of the extracted message to at least a portion of the plurality of computing devices comprises modifying the extracted message based on the destination criteria.

In certain example implementations, the rule further includes device prioritization criteria, and wherein sending the version of the extracted message to at least a portion of the plurality of computing devices is based on the device prioritization criteria. According to an example implementation of the disclosed technology, the rule includes device acknowledgement criteria, and wherein sending the version of the extracted message to at least a portion of the plurality of computing devices is repeated for select devices until an acknowledgement is received.

In accordance with an example implementation of the disclosed technology, rule may include customization data corresponding to attributes associated with plurality of computing devices, and wherein the extracted message is modified based on the customization data.

Certain example implementations of the disclosed technology may maintain a copy of the rule on at least one computing system (such as a first connection server) for forwarding the rule to one or more additional computing systems. For example, messages may be propagated in an efficient manner to the end target devices by having the various servers communicate the rule to one another. In certain example implementations, the message may be extracted, modified, etc. at each computing system before it is delivered to the end target computing devices that are associated with each given server. In certain example implementations, the rule can include time-dependent criteria, wherein sending the extracted message to at least a portion of the plurality of computing devices may be based on the time-dependent criteria.

In an example implementation, extracting the message may include modifying the message based, at least in part, on the routing instructions. In an example implementation, the rule may further include time criteria, including one or more of a start time or a stop time, and wherein sending the extracted message to the at least two of the plurality of computing devices may be controlled by the time criteria.

In an example implementation, the rule may include destination criteria, and sending the extracted message to the at least two of the plurality of computing devices can include translating the extracted message based on the destination criteria. For example, if the message is written in English, but is destined for a region in Mexico, the message may be translated into Spanish at the connection server. In certain example implementations, the rule may contain pre-translated messages.

In an example implementation, the rule can include device prioritization criteria, and sending the extracted message to the at least two of the plurality of computing devices may be based on the device prioritization criteria. In certain example implementations, the rule can include device acknowledgement criteria, and sending the extracted message to at least two of the plurality of computing devices may be repeated for select devices until an acknowledgement is received.

According to example implementations, certain technical effects can be provided, such as creating certain systems and methods that provide efficient dissemination of many messages to devices. Example implementations of the disclosed technology can provide the further technical effects of providing systems and methods for reducing the overhead associated with routing messages to devices.

In example implementations of the disclosed technology, the computing device 300 may include any number of hardware and/or software applications that are executed to facilitate any of the operations. In example implementations, one or more I/O interfaces may facilitate communication between the computing device 300 and one or more input/output devices. For example, a universal serial bus port, a serial port, a disk drive, a CD-ROM drive, and/or one or more user interface devices, such as a display, keyboard, keypad, mouse, control panel, touch screen display, microphone, etc., may facilitate user interaction with the computing device 300. The one or more I/O interfaces may be utilized to receive or collect data and/or user instructions from a wide variety of input devices. Received data may be processed by one or more computer processors as desired in various implementations of the disclosed technology and/or stored in one or more memory devices.

One or more network interfaces may facilitate connection of the computing device 300 inputs and outputs to one or more suitable networks and/or connections; for example, the connections that facilitate communication with any number of sensors associated with the system. The one or more network interfaces may further facilitate connection to one or more suitable networks; for example, a local area network, a wide area network, the Internet, a cellular network, a radio frequency network, a Bluetooth enabled network, a Wi-Fi enabled network, a satellite-based network any wired network, any wireless network, etc., for communication with external devices and/or systems. As desired, implementations of the disclosed technology may include the computing device 300 with more or less of the components illustrated in FIG. 3.

The various aspects described herein are presented as methods, devices (or apparatus), systems, and articles of manufacture that may include a number of components, elements, members, modules, nodes, peripherals, or the like. Further, these methods, devices, systems, and articles of manufacture may include or not include additional components, elements, members, modules, nodes, peripherals, or the like.

According to example implementations, the terms: computing device, server, messaging server, connection server, and/or mobile computing device, as used herein, may be a CPU, or conceptualized as a CPU (for example, the CPU 302 of FIG. 3). In certain example implementations, the computing device (CPU) may be coupled, connected, and/or in communication with one or more peripheral devices, such as display, navigation system, stereo, entertainment center, Wi-Fi access point, etc. In another example implementation, the term computing device or mobile computing device, as used herein, may refer to a mobile computing device, such as a smartphone, mobile station (MS), terminal, cellular phone, cellular handset, personal digital assistant (PDA), smartphone, wireless phone, organizer, handheld computer, desktop computer, laptop computer, tablet computer, set-top box, television, appliance, game device, medical device, display device, or some other like terminology. In an example embodiment, the mobile computing device may output content to its local display and/or speaker(s). In another example implementation, the mobile computing device may output content to an external display device (e.g., over Wi-Fi) such as a TV or an external computing system.

Furthermore, the various aspects described herein may be implemented using standard programming or engineering techniques to produce software, firmware, hardware, or any combination thereof to control a computing device to implement the disclosed subject matter. The term “article of manufacture” as used herein is intended to encompass a computer program accessible from any computing device, carrier, or media. For example, a computer-readable medium may include: a magnetic storage device such as a hard disk, a floppy disk or a magnetic strip; an optical disk such as a compact disk (CD) or digital versatile disk (DVD); a smart card; and a flash memory device such as a card, stick or key drive. Additionally, it should be appreciated that a carrier wave may be employed to carry computer-readable electronic data including those used in transmitting and receiving electronic data such as electronic mail (e-mail) or in accessing a computer network such as the Internet or a local area network (LAN). Of course, a person of ordinary skill in the art will recognize many modifications may be made to this configuration without departing from the scope or spirit of the claimed subject matter.

As used herein, unless otherwise specified the use of the ordinal adjectives “first,” “second,” “third,” etc., to describe a common object, merely indicate that different instances of like objects are being referred to, and are not intended to imply that the objects so described must be in a given sequence, either temporally, spatially, in ranking, or in any other manner.

In accordance with certain implementations of the disclosed technology, users may “opt-in” or “opt-out” by explicitly indicating or authorizing the receipt of messages and/or certain types of messages.

Throughout the specification and the claims, numerous specific details are set forth. However, it is to be understood that implementations of the disclosed technology may be practiced without these specific details. In other instances, well-known methods, structures and techniques have not been shown in detail in order not to obscure an understanding of this description. References to “one implementation,” “an implementation,” “example implementation,” “various implementations,” etc., indicate that the implementation(s) of the disclosed technology so described may include a particular feature, structure, or characteristic, but not every implementation necessarily includes the particular feature, structure, or characteristic. Further, repeated use of the phrase “in one implementation” does not necessarily refer to the same implementation, although it may.

Throughout the specification and the claims, the following terms take at least the meanings explicitly associated herein, unless the context clearly dictates otherwise. The term “connected” means that one function, feature, structure, or characteristic is directly joined to or in communication with another function, feature, structure, or characteristic. The term “coupled” means that one function, feature, structure, or characteristic is directly or indirectly joined to or in communication with another function, feature, structure, or characteristic. The term “or” is intended to mean an inclusive “or.” Further, the terms “a,” “an,” and “the” are intended to mean one or more unless specified otherwise or clear from the context to be directed to a singular form.

Certain implementations of the disclosed technology are described above with reference to block and flow diagrams of systems and methods and/or computer program products according to example implementations of the disclosed technology. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, or may not necessarily need to be performed at all, according to some implementations of the disclosed technology.

These computer-executable program instructions may be loaded onto a general-purpose computer, a special-purpose computer, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks. As an example, implementations of the disclosed technology may provide for a computer program product, comprising a computer-usable medium having a computer-readable program code or program instructions embodied therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special-purpose hardware and computer instructions.

Certain implementations of the disclosed technology are described above with reference to mobile computing devices. Those skilled in the art recognize that there are several categories of mobile devices, generally known as portable computing devices that can run on batteries but are not usually classified as laptops. For example, mobile devices can include, but are not limited to portable computers, tablet PCs, Internet tablets, PDAs, ultra mobile PCs (UMPCs) and smartphones.

While certain implementations of the disclosed technology have been described in connection with what is presently considered to be the most practical and various implementations, it is to be understood that the disclosed technology is not to be limited to the disclosed implementations, but on the contrary, is intended to cover various modifications and equivalent arrangements included within the scope of the appended claims. Although specific terms are employed herein, they are used in a generic and descriptive sense only and not for purposes of limitation.

This written description uses examples to disclose certain implementations of the disclosed technology, including the best mode, and also to enable any person skilled in the art to practice certain implementations of the disclosed technology, including making and using any devices or systems and performing any incorporated methods. The patentable scope of certain implementations of the disclosed technology is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A computer-implemented method, comprising:
receiving, at one or more computing systems, a rule comprising a message and routing instructions for dissemination of the message to a plurality of wireless mobile computing devices associated with one or more service providers, wherein the plurality of wireless mobile computing devices are configured to communicate with the one or more computing systems;
extracting from the rule, by at least one of the one or more computing systems, the message and routing instructions, wherein the routing instructions comprise instructions to send the message to the plurality of devices associated with the one or more service providers;
determining, from the routing instructions and from device information, the plurality of wireless mobile computing devices for dissemination of the message; and
sending, by a cloud-based messaging system and based on the routing instructions and a connection status, the extracted message to at least two of the plurality of wireless mobile computing devices associated with the one or more service providers.

2. The method of claim 1, wherein the extracting the message comprises modifying the message based, at least in part, on the routing instructions.

3. The method of claim 1, wherein the rule further comprises a time criteria, including one or more of a start time or a stop time, and wherein sending the extracted message to the at least two of the plurality of wireless mobile computing devices is controlled by the time criteria.

4. The method of claim 1, wherein the rule further comprises destination criteria, and wherein sending the extracted message to the at least two of the plurality of wireless mobile computing devices comprises translating language of the extracted message based on the destination criteria.

5. The method of claim 1, wherein the rule further comprises device prioritization criteria, and wherein sending the extracted message to the at least two of the plurality of computing devices is based on the device prioritization criteria.

6. The method of claim 1, wherein the rule further comprises device acknowledgement criteria, and wherein sending the extracted message to at least two of the plurality of computing devices is repeated for select devices until an acknowledgement is received.

7. A computing system comprising:
one or more processors; and
memory storing instructions that when executed by the one or more processors cause the computing system to perform operations comprising:
receiving a rule comprising a message and routing instructions for dissemination of the message to a plurality of wireless mobile computing devices associated with one or more service providers, wherein the plurality of wireless mobile computing devices are configured to communicate with the computing system;
extracting from the rule, the message and routing instructions, wherein the routing instructions comprise instructions to send the message to the plurality of devices associated with the one or more service providers;
determining, from the routing instructions and from device information, the plurality of wireless mobile computing devices for dissemination of the message; and
sending, by a cloud-based messaging system and based on the routing instructions and a connection status, the extracted message to at least two of the plurality of wireless mobile computing devices associated with the one or more service providers.

8. The system of claim 7, wherein the computing system is further configured to modify the extracted message based, at least in part, on the routing instructions.

9. The system of claim 7, wherein the rule further comprises a time criteria, including one or more of a start time or a stop time, and wherein the computing system is further configured to send the extracted message to the at least two of the plurality of wireless mobile computing devices based the time criteria.

10. The system of claim 7, wherein the rule further comprises destination criteria, and wherein the computing system is further configured to translate a language of the extracted message based on the destination criteria.

11. The system of claim 7, wherein the rule further comprises device prioritization criteria, and wherein the computing system is further configured to send the extracted message to the at least two of the plurality of wireless mobile computing devices based on the device prioritization criteria.

12. The system of claim 7, wherein the rule further comprises device acknowledgement criteria, and wherein the computing system is further configured to repeat sending the extracted message to selected devices until an acknowledgement is received.

13. A non-transitory computer-readable medium storing instructions, that when executed by a computer device having one or more processors, cause the computer device to perform a method comprising:
receiving, at one or more computing systems, a rule comprising a message and routing instructions for dissemination of the message to a plurality of wireless mobile computing devices associated with one or more service providers, wherein the plurality of wireless mobile computing devices are configured to communicate with the one or more computing systems;
extracting from the rule, by at least one of the one or more computing systems, the message and routing instructions, wherein the routing instructions comprise instructions to send the message to the plurality of devices associated with the one or more service providers;
determining, from the routing instructions and from device information, the plurality of wireless mobile computing devices for dissemination of the message; and
sending, by a cloud-based messaging system and based on the routing instructions and a connection status, the extracted message to at least two of the plurality of wireless mobile computing devices associated with the one or more service providers.

14. The computer-readable medium of claim 13, wherein the extracting the message comprises modifying the message based, at least in part, on the routing instructions.

15. The computer-readable medium of claim 13, wherein the rule further comprises a time criteria, including one or more of a start time or a stop time, and wherein sending the extracted message to the at least two of the plurality of wireless mobile computing devices is controlled by the time criteria.

16. The computer-readable medium of claim 13, wherein the rule further comprises destination criteria, and wherein sending the extracted message to the at least two of the plurality of wireless mobile computing devices comprises translating a language of the extracted message based on the destination criteria.

17. The computer-readable medium of claim 13, wherein the rule further comprises device prioritization criteria, and wherein sending the extracted message to the at least two of the plurality of wireless mobile computing devices is based on the device prioritization criteria.

18. The computer-readable medium of claim 13, wherein the rule further comprises device acknowledgement criteria, and wherein sending the extracted message to at least two of the plurality of wireless mobile computing devices is repeated for select devices until an acknowledgement is received.
